(19) United States
(12) Patent Application Publication
(10) Pub. No.: US 2003/0173518 A1
(43) Pub. Date: Sep. 18, 2003

(54) Visible/infrared imaging camera

(75) Inventor: Takao Ozaki, Saitama-shi (JP)

Correspondence Address: Ronald R. Snider, Snider & Associates, P.O. Box 27613, Washington, DC, 20038-7613, US

(73) Assignee: Fuji Photo Optical Co., Ltd., Saitama-shi (JP)

(21) Appl. No.: 10/366,458

(22) Filed: Feb. 14, 2003

(30) Foreign Application Priority Data
Mar. 18, 2002 (JP) 2002-073534

(51) Int. Cl. G01J 5/00

(52) U.S. Cl. 250/330

(57) ABSTRACT

In a visible/infrared imaging camera comprising lightwave separating means for separating light into visible and infrared light components, and visible and infrared light camera units for capturing visible and infrared light images formed by the visible and infrared light components, respectively, the infrared light camera unit is supported so as to be movable axially of the infrared light component emitted from the lightwave separating means, thereby adjusting the focusing of the infrared light image.

### RELATED APPLICATIONS

This application claims the priority of Japanese Patent Application No. 2002-073534 filed on Mar. 18, 2002, which is incorporated herein by reference.

### BACKGROUND OF THE INVENTION

1. Field of the Invention

The present invention relates to a visible/infrared imaging camera adapted to separate light from an object into visible and infrared light components, so as to capture visible and infrared light images of the object at the same time. More specifically, the present invention relates to a visible/infrared imaging camera adapted to adjust focusing of the infrared light image according to the zoom ratio of the camera.

2. Description of the Prior Art

A photographing method called “virtual studio system” has conventionally been known, in which an object is photographed against the backdrop of a blue sheet or the like in a room known as virtual studio, and then the object image is extracted alone so as to be usable for combination with other backdrop images or the like.

A new photographing system has recently been devised in the virtual studio and getting attention. This photographing system is configured such that, while objects are irradiated with infrared light (near infrared light), visible and infrared light images of the object are captured by a visible/infrared imaging camera at the same time, information about the distance from the camera to an object is obtained from thus captured infrared light image, and then, according to thus obtained distance information, only the part of visible light image of the object located at a given distance from the camera can selectively be extracted from the whole captured visible light image.

Visible/infrared imaging cameras currently in use in general are configured such that light from an object transmitted through one zoom lens system is separated into visible and infrared light components by a color-decomposing prism or the like, so that the visible and infrared light components are made incident on visible and infrared light camera units, respectively, whereas the zoom lens system employed is set such that the imaging distance of the visible light image can be kept substantially constant even when the distance to the object or the zoom ratio is changed. On the other hand, the imaging distance of the infrared light image shifts when the distance to the object or the zoom ratio is changed. When the zoom ratio is changed greatly in particular, the amount of shift may become so great that the infrared light image cannot be brought into focus by the focusing adjustment of the zoom lens system alone.

Such a problem also occurs in the visible/infrared imaging camera for the above-mentioned new photographing system. When an infrared light image cannot be brought into focus, accurate information about the distance from the camera to the object may not be obtained according to the captured infrared light image, whereby the photographing system itself may fail to function sufficiently.

Though the above-mentioned problem will be overcome if a zoom lens system which can keep the imaging distance of the infrared light image even when the zoom ratio changes is developed, such a zoom lens system is hard to develop since an enormous cost is expected to be required therefor.

### SUMMARY OF THE INVENTION

In view of such circumstances, it is an object of the present invention to provide a low-cost visible/infrared imaging camera which can focus infrared light images accurately even when the zoom ratio is changed.

For achieving the above-mentioned object, the present invention provides a visible/infrared imaging camera comprising a zoom lens system; lightwave separating means for separating light transmitted through the zoom lens system into visible and infrared light components and emitting thus separated light components; a visible light camera unit, disposed downstream a part of the lightwave separating means for emitting the visible light component, for capturing a visible light image formed by the visible light component emitted from the lightwave separating means; and an infrared light camera unit, disposed downstream a part of the lightwave separating means for emitting the infrared light component, for capturing an infrared light image formed by the infrared light component emitted from the lightwave separating means;

the visible/infrared imaging camera further comprising moving/supporting means for supporting the infrared light camera unit such that the infrared light camera unit is movable axially of the infrared light component emitted from the lightwave separating means, the moving/supporting means moving the infrared light camera unit so as to adjust focusing of the infrared light image.

The visible/infrared imaging camera in accordance with the present invention may comprise switching means for allowing a switching operation from outside, whereas the infrared light camera unit may be moved to a position corresponding to a zoom ratio of the zoom lens system in response to the switching operation with respect to the switching means.

The moving/supporting means may comprise a stationary stage relatively fixed with respect to the lightwave separating means; a movable stage, movably attached to the stationary stage, for holding the infrared light camera unit; and a motor for driving the movable stage.

In this case, the visible/infrared imaging camera may further comprise switching means including an operating section for allowing an operation from outside, and a controller for controlling the driving of the motor in response to a switching operation with respect to the operating section so as to move the infrared light camera unit to a position corresponding to a zoom ratio of the zoom lens system.

### BRIEF DESCRIPTION OF THE DRAWINGS

FIG. 1 is a schematic diagram of the visible/infrared imaging camera in accordance with an embodiment of the present invention; and

FIG. 2 is a schematic diagram of a switching means provided in the moving/supporting means shown in FIG. 1.

### DESCRIPTION OF THE PREFERRED EMBODIMENTS

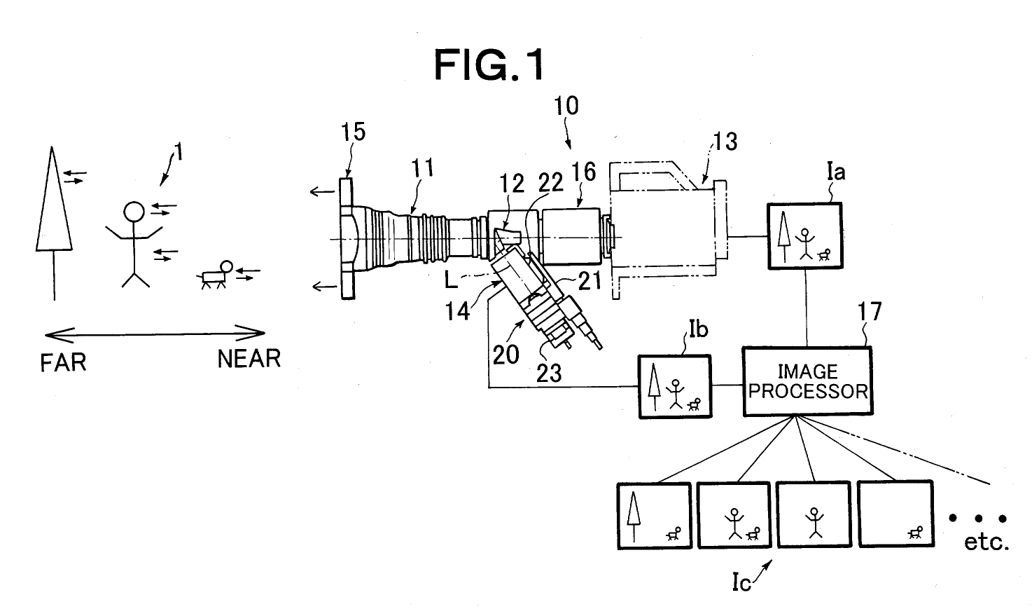

In the following, embodiments of the present invention will be explained with reference to the drawings. FIG. 1 is a diagram schematically showing the configuration of the visible/infrared imaging camera in accordance with an embodiment of the present invention and its photographing system.

The depicted visible/infrared imaging camera 10 is a camera utilized for virtual studio photography utilized in special effects for movies and the like. The camera 10 comprises a zoom lens system 11 constituted by an undepicted optical lens group arranged within a lens barrel; a lightwave separating means 12 constituted by a color-decomposing prism; a visible light camera unit 13 for capturing visible light images; and an infrared light camera unit 14 for capturing infrared light images. Also, an infrared light emitting unit 15 for emitting infrared light (near infrared light) to objects is provided at the front end part of the camera, whereas a relay lens system 16 is disposed between the lightwave separating means 12 and the visible light camera unit 13.

The visible/infrared imaging camera 10 carries out photographing, while the infrared light emitting unit 15 emits infrared light to objects 1. Light reflected by the objects 1 so as to be made incident on and then transmitted through the zoom lens system 11 is divided into two, i.e., visible and infrared light components, by the lightwave separating means 12, so as to be emitted therefrom. Thus emitted visible light component is transmitted through the relay lens system 16 so as to enter the visible light camera unit 13, whereas the infrared light component is made incident on the infrared light camera unit 14.

The visible light camera unit 13 is disposed downstream the part of lightwave separating means 12 for emitting the visible light component by way of the relay lens system 16, and comprises mechanisms for capturing visible light images such as visible light image pickup devices and visible light image forming circuits which are not depicted, so as to capture a visible light image Ia formed by the incident visible light component and output its image information. On the other hand, the infrared light camera unit 14 is disposed directly downstream the part of lightwave separating means 12 for emitting the infrared light component, and comprises mechanisms for capturing infrared light images such as infrared light image pickup devices and infrared light image forming circuits which are not depicted, so as to capture an infrared light image Ib formed by the incident infrared light component and output its image information.

Both of the respective image information items from the visible light camera unit 13 and infrared light camera unit 14 are fed into an image processor 17. The image processor 17 obtains information about the distance to each of the objects 1 according to the image information from the infrared light camera unit 14, and carries out a predetermined image processing operation with respect to the visible light image information from the visible light camera unit 13 according to the distance information, so as to produce processed images Ic obtained by erasing or extracting only predetermined object image parts from the whole visible light image Ia.

The visible/infrared imaging camera 10 is configured such that its zoom ratio can be changed electrically, whereas the imaging distance of the visible light image Ia caused by the zoom lens system 11 is set so as to be kept substantially constant (e.g., 48 mm in air) even when the distance to the object or zoom ratio is changed. On the other hand, the imaging distance of the infrared light image Ib shifts when the distance to the object or the zoom ratio is changed. When the zoom ratio is changed greatly in particular, the infrared light image Ib cannot accurately be brought into focus by the focusing adjustment of the zoom lens system 11 alone. For adjusting the focus of the infrared light image Ib in response to the change in zoom ratio, the visible/infrared imaging camera 10 is equipped with a moving/supporting means 20 for the infrared light camera unit 14.

The moving/supporting means 20 will now be explained. As shown in FIG. 1, the moving/supporting means 20 comprises a stationary stage 21 relatively fixed with respect to the lightwave separating means 12, a movable stage 22 attached to the stationary stage 21 so as to be movable along the axis L of the infrared light component, a motor 23 for driving the movable stage 22, and a driving force transmission mechanism (not depicted) for transmitting the driving force from the motor 23 to the movable stage 22; and is configured such that the infrared light camera unit 14 attached to the movable stage 22 is movable axially of the infrared light component emitted from the lightwave separating means 12.

For preventing dust and the like from entering the space about the axis of the infrared light component, a ring-shaped dustproof member (not depicted) having such a flexibility as to respond to the movement of the infrared light camera unit 14 is disposed between the part of lightwave separating means 12 for emitting the infrared light component and the part of infrared light camera unit 14 for receiving the infrared light component.

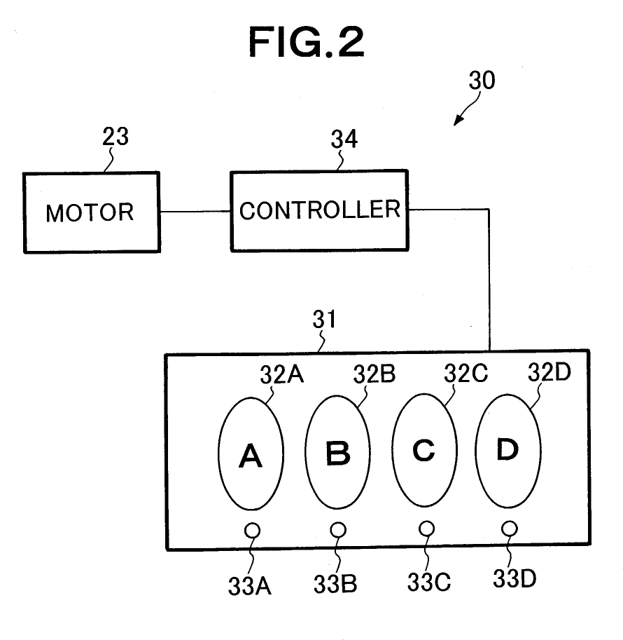

Also, the moving/supporting means 20 is provided with a switching means 30 shown in FIG. 2. Here, FIG. 2 is a diagram schematically showing the configuration of the switching means 30. As shown in FIG. 2, the switching means 30 comprises an operating section 31 disposed at a position operable by a photographer or the like, and a controller 34 for controlling the driving of the motor 23 in response to a switching operation with respect to the operating section 31.

The operating section 31 comprises a plurality of (four in the example shown in FIG. 2) switching buttons 32A to 32D, and display lamps 33A to 33D for indicating which buttons are currently chosen. The operating section 31 is configured such that, when a switching operation is carried out by the photographer or the like, a selection signal indicating which buttons are selected is outputted to the controller 34. On the other hand, the controller 34 includes a CPU, a memory storing a predetermined program, and a motor driver, so as to output a predetermined driving current for driving the motor 23 from the motor driver according to the selection signal from the operating section 31.

In response to a driving control signal outputted from the controller 34, the motor 23 drives the movable stage 22, so that the infrared light camera unit 14 held by the movable stage 22 is moved to a predetermined position. Positions of the infrared light camera unit 14 at which infrared light images come into focus have been determined beforehand with respect to various zoom ratios of the zoom lens system 11, whereas the four switching buttons 32A to 32D of the operating section 31 have been set so as to correspond to respective ranges of zoom ratio of the zoom lens system 11. When the photographer or the like determines the zoom ratio of the zoom lens system 11 and chooses a button corresponding to the zoom ratio among the four switching buttons 32A to 32D, the infrared light camera unit 14 moves along the axis L of the infrared light component to the position corresponding to the zoom ratio of the zoom lens system 11, whereby the focusing of the infrared light image can be adjusted.

Though the photographer or the like determines the zoom ratio of the zoom lens system 11 and then switches the switching means 30 so as to adjust the focusing of the infrared light image in the above-mentioned example, zoom ratio detecting means for automatically detecting the zoom ratio of the zoom lens system 11 may be provided, such that the movement of the infrared light camera unit 14 is automatically controlled according to the zoom ratio detected by the zoom ratio detecting means.

Alternatively, the position of the infrared light camera unit 14 may be adjusted while the focusing state of the infrared light image is determined on a monitor, so as to adjust the focusing of the infrared light image.

Though the embodiment in which the present invention is applied to a visible/infrared imaging camera for virtual studio photography is explained in the foregoing, the present invention is also applicable to various visible/infrared imaging cameras such as those in which a single lens system is equipped with a visible light camera unit and an infrared light camera unit, e.g., those for night-watch and traffic violation detection.

As explained in detail in the foregoing, the visible/infrared imaging camera in accordance with the present invention comprises moving/supporting means for supporting the infrared light camera unit disposed downstream the part of lightwave separating means for emitting the infrared light component such that the infrared light camera unit is movable axially of the infrared light component, and causes the moving/supporting means to move the infrared light camera unit, so as to adjust the focusing of infrared light images, thus being effective in the following points.

Namely, it can always form infrared light images in an appropriate focusing state by causing the moving/supporting means to move the infrared light camera unit axially of the infrared light component, even when the imaging distance of infrared light images is changed upon altering the zoom ratio of the zoom lens system.

Since the moving means for the infrared light camera unit in the present invention can be realized in a simple configuration, a visible/infrared imaging camera equipped with a mechanism for adjusting the focusing of infrared light images can be made as a commercial product at a low cost.

What is claimed is:

1. A visible/infrared imaging camera comprising a zoom lens system; lightwave separating means for separating light transmitted through said zoom lens system into visible and infrared light components and emitting thus separated light components; a visible light camera unit, disposed downstream a part of said lightwave separating means for emitting said visible light component, for capturing a visible light image formed by said visible light component emitted from said lightwave separating means; and an infrared light camera unit, disposed downstream a part of said lightwave separating means for emitting said infrared light component, for capturing an infrared light image formed by said infrared light component emitted from said lightwave separating means;
said visible/infrared imaging camera further comprising moving/supporting means for supporting said infrared light camera unit such that said infrared light camera unit is movable axially of said infrared light component emitted from said lightwave separating means, said moving/supporting means moving said infrared light camera unit so as to adjust focusing of said infrared light image.

2. A visible/infrared imaging camera according to claim 1, further comprising switching means for allowing a switching operation from outside, said infrared light camera unit being moved to a position corresponding to a zoom ratio of said zoom lens system in response to said switching operation with respect to said switching means.

3. A visible/infrared imaging camera according to claim 1, wherein said moving/supporting means comprises a stationary stage relatively fixed with respect to said lightwave separating means; a movable stage, movably attached to said stationary stage, for holding said infrared light camera unit; and a motor for driving said movable stage.

4. A visible/infrared imaging camera according to claim 1, wherein said moving/supporting means comprises a stationary stage relatively fixed with respect to said lightwave separating means; a movable stage, movably attached to said stationary stage, for holding said infrared light camera unit; and a motor for driving said movable stage; and
wherein said visible/infrared imaging camera further comprises switching means including an operating section for allowing an operation from outside, and a controller for controlling said driving of said motor in response to a switching operation with respect to said operating section so as to move said infrared light camera unit to a position corresponding to a zoom ratio of said zoom lens system.
